(19) United States
(12) Patent Application Publication
(10) Pub. No.: US 2026/0077270 A1
(43) Pub. Date: Mar. 19, 2026

(54) METHOD FOR CONTROLLING VIRTUAL OBJECT, APPARATUS FOR CONTROLLING VIRTUAL OBJECT, STORAGE MEDIUM, AND ELECTRONIC DEVICE

(71) Applicant: NETEASE (HANGZHOU) NETWORK CO., LTD., Hangzhou (CN)

(72) Inventor: Yangchen JIANG, Hangzhou (CN)

(21) Appl. No.: 18/994,036

(22) PCT Filed: Feb. 3, 2023
(86) PCT No.: PCT/CN2023/074453

§ 371 Date: Jan. 13, 2025

(30) Foreign Application Priority Data
Jul. 12, 2022 (CN) 202210822696.0

(51) Int. Cl. A63F 13/837; A63F 13/2145; A63F 13/533; A63F 13/537

(52) U.S. Cl. CPC A63F 13/837; A63F 13/2145; A63F 13/533; A63F 13/537

(57) ABSTRACT

The present disclosure provides a method for controlling a virtual object. The method includes: displaying a shooting aiming mark and a graphical user interface of a second-type attack widget, where the target virtual object is configured with a virtual firearm, and the shooting aiming mark assists in aiming of the virtual firearm; replacing, in response to a touch operation for the second-type attack widget, the shooting aiming mark with a second-type aiming mark, and determining a to-be-attacked virtual object aimed at by the second-type aiming mark based on the touch operation; and controlling the target virtual object to attack the to-be-attacked virtual object in a second-type attack mode.

The present disclosure is a 371 national phase application of PCT Application No. PCT/CN2023/074453 filed 3 Feb. 2023, which claims priority to Chinese Patent Application No. 202210822696.0 filed with the China National Intellectual Property Administration on 12 Jul. 2022 and titled “METHOD FOR CONTROLLING VIRTUAL OBJECT, APPARATUS FOR CONTROLLING VIRTUAL OBJECT, STORAGE MEDIUM, AND ELECTRONIC DEVICE”, the entire contents of both of which applications are hereby incorporated by reference for all purposes.

### TECHNICAL FIELD

The present disclosure relates to the field of computers, and specifically relates to a method for controlling a virtual object, an apparatus for controlling a virtual object, a computer-readable storage medium, and a computer device.

### BACKGROUND

In recent years, with the development and popularization of computer device technologies, more and more application programs with three-dimensional virtual environments have emerged, such as: a virtual reality application program, a three-dimensional map program, a military simulation program, a first person shooting (FPS) game, and a role-playing game (RPG).

In related technologies, when playing a FPS game, a user only can perform a firearm shooting operation; and when playing a RPG game, the user can only release and use skills.

In a process of research and practice on related technologies, inventors of the present disclosure found that the user of related technologies fails to perform both the firearm shooting operation and skill release and use while playing a game, result in monotonous game play.

### SUMMARY

Embodiments of the present disclosure provide a method, system, and apparatus for controlling a virtual object, which improve user engagement and increase the overall fun of the gaming experience.

According to a first aspect, the present disclosure provides a method for controlling a virtual object. The method includes: displaying a graphical user interface, where the graphical user interface comprises a virtual scenario, a target virtual object located in the virtual scenario, a shooting aiming mark, and a second-type attack widget, the target virtual object is configured with a virtual firearm, and the shooting aiming mark is configured to assist in aiming of the virtual firearm; in response to a touch operation for the second-type attack widget, replacing the shooting aiming mark with a second-type aiming mark, and determining a to-be-attacked virtual object aimed at by the second-type aiming mark based on the touch operation, where the second-type aiming mark is used to assist in aiming of a second-type attack; and controlling the target virtual object to attack the to-be-attacked virtual object in a second-type attack mode.

According to a second aspect, the present disclosure provides one or more non-transitory computer-readable storage media containing, in any combination, computer program code that, when executed by a computer system, performs the operations described in the above method for controlling a virtual object.

According to a third aspect, the present disclosure provides a system, comprising one or more memories collectively containing one or more programs, and one or more processors, where the one or more processors are configured to, individually or collectively, perform the operations described in the above method for controlling a virtual object.

### BRIEF DESCRIPTION OF THE DRAWINGS

To more clearly describe technical solutions of embodiments of the present disclosure, drawings to be implemented in the description of the embodiments will be briefly introduced below. Apparently, the drawings described below are merely some embodiments of the present disclosure. For those skilled in the art, other drawings may also be obtained based on these drawings without creative work.

FIG. 1a is schematic system diagram of a method for controlling a virtual object provided in an embodiment of the present disclosure.

FIG. 1b is a first schematic flowchart of a method for controlling a virtual object provided in an embodiment of the present disclosure.

FIG. 1c is a first schematic diagram of a graphical user interface provided in an embodiment of the present disclosure.

FIG. 1d is a second schematic diagram of a graphical user interface provided in an embodiment of the present disclosure.

FIG. 1e is a third schematic diagram of a graphical user interface provided in an embodiment of the present disclosure.

FIG. 1f is a fourth schematic diagram of a graphical user interface provided in an embodiment of the present disclosure.

FIG. 1g is a fifth schematic diagram of a graphical user interface provided in an embodiment of the present disclosure.

FIG. 1h is a sixth schematic diagram of a graphical user interface provided in an embodiment of the present disclosure.

FIG. 1i is a seventh schematic diagram of a graphical user interface provided in an embodiment of the present disclosure.

FIG. 2 is a schematic structural diagram of an apparatus for controlling a virtual object provided in an embodiment of the present disclosure; and

FIG. 3 is a schematic structural diagram of a computer device provided in an embodiment of the present disclosure.

### DETAILED DESCRIPTION

Technical solutions of embodiments of the present disclosure will be described clearly and completely below in combination with the drawings in the embodiments of the present disclosure. Apparently, the described embodiments are merely some embodiments, instead of all embodiments, of the present disclosure. All other embodiments obtained by those skilled in the art based on the embodiments of the present disclosure without creative work are encompassed within the scope of protection of the present disclosure.

The embodiments of the present disclosure provide a method, system, and apparatus for controlling a virtual object. Specifically, the method for controlling a virtual object in an embodiment of the present disclosure may be implemented by a computer device, where the computer device may be a device, such as a terminal or a server. The terminal may be a terminal device, such as a smart phone, a tablet computer, a notebook computer, a touch screen, a game machine, a personal computer (PC), or a personal digital assistant (PDA). The terminal device may further include a client. The client may be, e.g., a game application client, a browser client carrying a game program, or an instant messaging client. The server may be a standalone physical server, or may be a server cluster or a distributed system composed of a plurality of physical servers, or may be a cloud server providing basic cloud computing service, such as cloud service, cloud database, cloud computing, cloud function, cloud storage, network service, cloud communication, middleware service, domain name service, security service, CDN, big data, and artificial intelligence platform.

For example, when the method for controlling a virtual object runs on the terminal, the terminal device stores a game application program, and presents a part of a game scenario in a game through a display component. The terminal device is configured to interact with a user through a graphical user interface, such as downloading, installing, and running the game application program through the terminal device. The terminal device may provide the graphical user interface to the user in a variety of ways, for example, rendering and displaying on a display screen of the terminal device, or presenting the graphical user interface by holographic projection. For example, the terminal device may include a touch screen and a processor. The touch screen is configured to present the graphical user interface and receive an operating instruction generated by the user acting on the graphical user interface. The graphical user interface includes a game screen. The processor is configured to run the game, generate the graphical user interface, respond to the operating instruction, and control the display of the graphical user interface on the touch screen.

For example, when running on the server, the method for controlling a virtual object may be a cloud game. The cloud game refers to a gaming method based on cloud computing. In a running mode of the cloud game, an entity for running the game application program is separated from an entity for presenting game screen, and the storage and running of the method for controlling a virtual object are completed on a cloud game server. The game screen presentation is completed on a cloud game client. The cloud game client is mainly configured to receive and transmit game data and present the game screen. For example, the cloud game client may be a display device that is close to a user side and has a data transmission function, such as a mobile terminal, a television set, a computer, a handheld computer, or a personal digital assistant, but the terminal device that performs virtual object control is a cloud game server in cloud. When playing a game, the user operates the cloud game client to transmit the operating instruction to the cloud game server. The cloud game server runs the game based on the operating instruction, encodes and compresses the data such as the game screen, and returns the encoded and compressed data to the cloud game client through a network. Finally, the cloud game client decodes the encoded and compressed data, and outputs the game screen.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when”or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

According to embodiments of the present disclosure, a graphical user interface is displayed, where the graphical user interface includes at least a virtual scenario, a target virtual object located in the virtual scenario, a shooting aiming mark, and a second-type attack widget, the target virtual object is configured with a virtual firearm, and the shooting aiming mark is configured to assist in aiming of the virtual firearm; in response to a touch operation for the second-type attack widget, the shooting aiming mark is replaced with a second-type aiming mark, a to-be-attacked virtual object aimed at by the second-type aiming mark is determined based on the touch operation, the second-type aiming mark is configured to assist in aiming of the second-type attack; and the target virtual object is controlled to attack the to-be-attacked virtual object in a second-type attack mode. In this way, by the touch operation of a user on the second-type attack widget, the original attack mode using a virtual firearm is transformed into the second-type attack mode. The disclosed approach combines a plurality of game types, improves the overall gameplay experience, and makes the game more enjoyable.

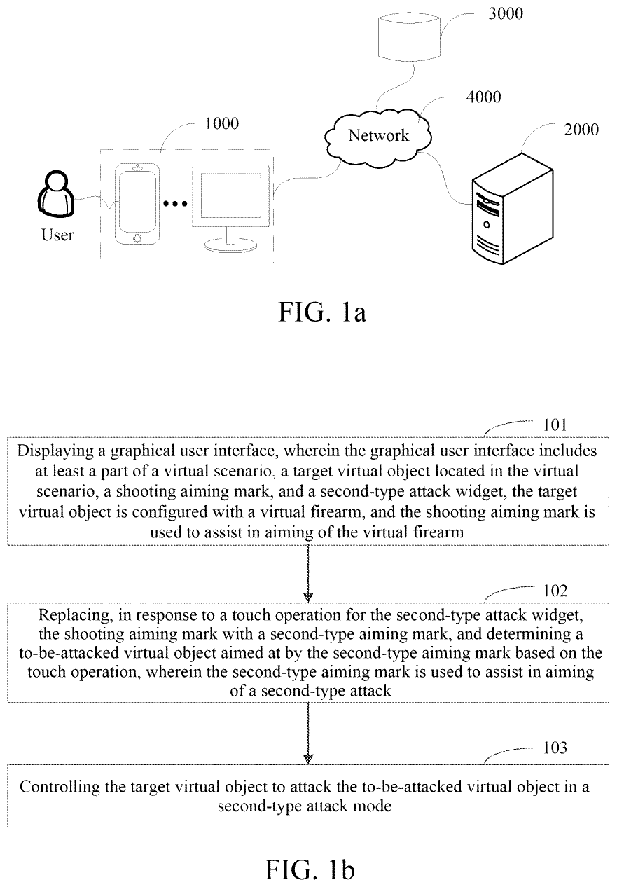

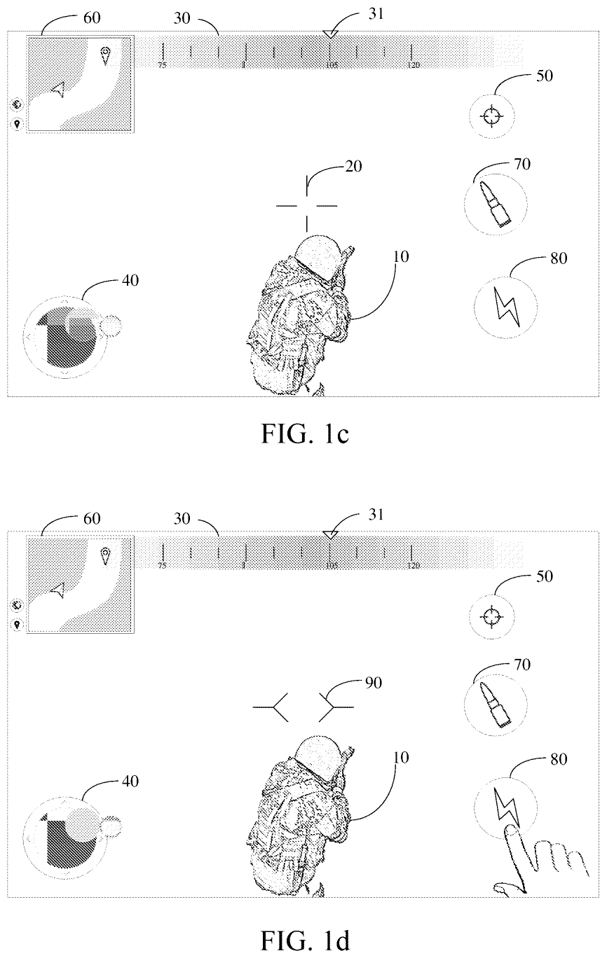

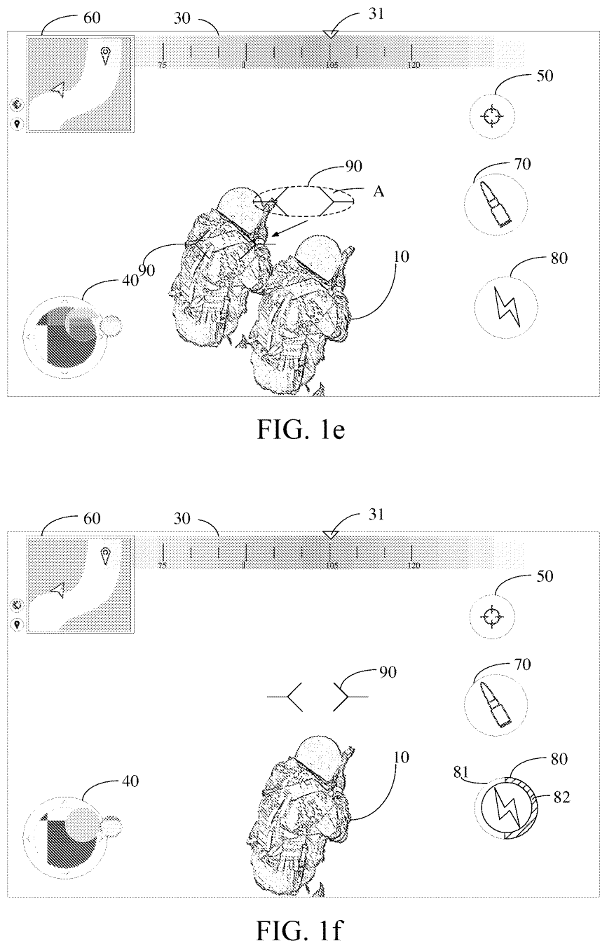

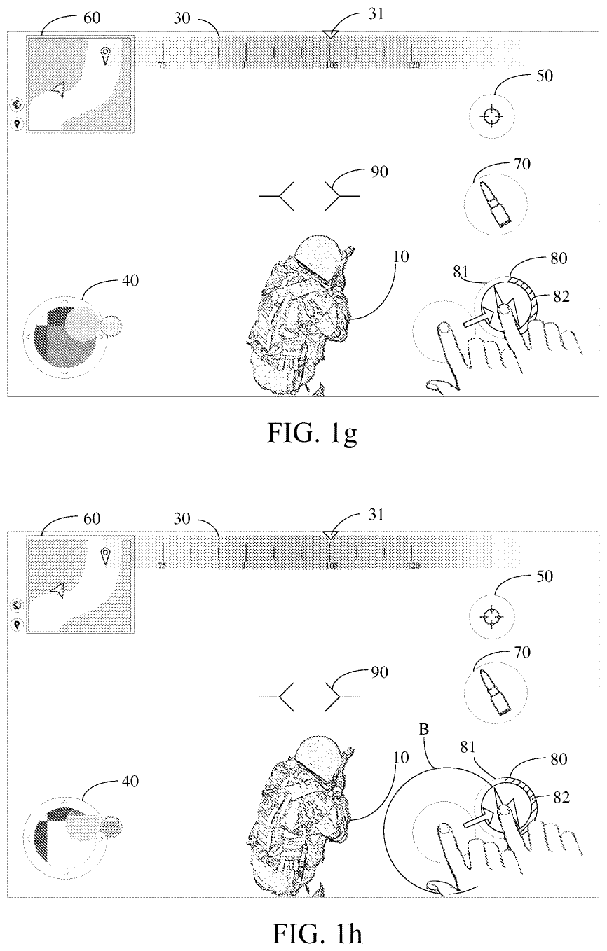

Referring to FIG. 1a, FIG. 1a is schematic system diagram of a method for controlling a virtual object provided in an embodiment of the present disclosure. The system may include at least one computer device 1000, at least one server 2000, at least one database 3000, and a network 4000. The computer device 1000 held by a user may be connected to servers of different games through the network 4000. The computer device 1000 is any device with computing hardware capable of supporting and executing a software product corresponding to a game. In addition, the computer device 1000 includes one or more multi-touch sensitive screens configured to sense and obtain an input through a touch or sliding operation performed by a user at a plurality of points on one or more touch screens. In addition, when the system includes a plurality of computer devices 1000, a plurality of servers 2000, and a plurality of networks 4000, different computer devices 1000 may be connected to each other through different networks 4000 and through different servers 2000. The network 4000 may be a wireless network or a wired network. For example, the wireless network may be a wireless local area network (WLAN), a local area network (LAN), a cellular network, a 2G network, a 3G network, a 4G network, a 5G network, etc. In addition, different computer devices 1000 may also be connected to other terminals or connected to servers using their own Bluetooth networks or hotspot networks. For example, a plurality of users may be online via different computer devices 1000, so that they are connected through appropriate networks and synchronized with each other, to support multi-user games. In addition, the system may include a plurality of databases 3000, where the plurality of databases 3000 are coupled to different servers 2000, and information related to the game environment may be continuously stored in the databases 3000 when different users are playing multi-user games online.

An embodiment of the present disclosure provides a method for controlling a virtual object. The method may be implemented by a terminal or a server. The embodiment of the present disclosure is illustrated when the method for controlling a virtual object is implemented by, for example, a terminal. The terminal includes a display component and a processor, and the display component is configured to present a graphical user interface and receive an operating instruction generated by a user acting on the display component. When the user operates the graphical user interface through the display component, the graphical user interface not only can control local content of the terminal in response to the received operating instruction, but also can control content of a peer server in response to the received operating instruction. For example, the operating instruction generated by the user acting on the graphical user interface includes an instruction for initiating a game application program, and the processor is configured to initiate the game application program after receiving the instruction for initiating the game application program provided by the user. In addition, the processor is configured to render and plot a graphical user interface associated with the game on the touch screen. The touch screen is a multi-touch sensitive screen that can sense touch or sliding operations simultaneously performed at a plurality of points on the screen. The user performs a touch operation on the graphical user interface using a finger. When detecting the touch operation, the graphical user interface controls different virtual objects in the graphical user interface of the game to perform actions corresponding to the touch operation. For example, the game may be any one of a casual game, an action game, a role-playing game, a strategy game, a sports game, a puzzle game, a first person shooting (FPS) game, and the like. The game may include a virtual scenario of a game plotted on the graphical user interface. In addition, the virtual scenario of the game may include one or more virtual objects, such as a virtual character, controlled by the user (or user). In addition, the virtual scenario of the game may further include one or more obstacles, such as railings, ravines, and walls, to restrict movement of the virtual object, such as restricting movement of one or more objects to a particular region within the virtual scenario. In some embodiments, the virtual scenario of the game further includes one or more elements, such as skills, scores, character health status, or energy, to provide the user with help and virtual services, and increase scores related to the user performance, etc. In addition, the graphical user interface may further present one or more indicators to provide the user with indication information. For example, the game may include a user-controlled virtual object and one or more other virtual objects (such as enemy characters). In an embodiment, the one or more other virtual objects are controlled by other users of the game. For example, the one or more other virtual objects may be controlled by a computer, such as a robot using an artificial intelligence (AI) algorithm, to implement a man-machine battle mode. For example, the virtual object owns various skills or abilities used by a game user to achieve his goals. For example, the virtual object owns one or more weapons, props, tools, etc. that can be used to eliminate other objects from the game. Such skills or abilities may be activated by the game user using one of a plurality of preset touch operations on the touch screen of the terminal. The processor may be configured to present a corresponding game screen in response to the operating instruction generated by the touch operation of the user.

It should be noted that the schematic system diagram of the system for controlling a virtual object shown in FIG. 1a is merely an example. The system for controlling a virtual object and the scenario are described in the embodiments of the present disclosure to more clearly illustrate the technical solutions of the embodiments of the present disclosure, and do not impose any limitation on the technical solutions provided in the embodiments of the present disclosure. As appreciated by those of ordinary skills in the art, with the evolution of the system for controlling a virtual object and the emergence of new service scenarios, the technical solutions provided in the embodiments of the present disclosure are also adapted to similar technical problems.

In the present embodiment, the description will be provided from the perspective of an apparatus for controlling a virtual object. The apparatus for controlling a virtual object specifically may be integrated into a computer device that comprises a storage unit and is equipped with a microprocessor to have computing power.

Referring to FIG. 1b, FIG. 1b is a first schematic flowchart of a method for controlling a virtual object provided in an embodiment of the present disclosure. The method for controlling a virtual object includes:

Step 101: displaying a graphical user interface, where the graphical user interface includes at least a part of a virtual scenario, a target virtual object located in the virtual scenario, a shooting aiming mark, and a second-type attack widget, the target virtual object is configured with a virtual firearm, and the shooting aiming mark is used to assist in aiming of the virtual firearm.

The graphical user interface displays a three-dimensional virtual scenario in the game scenario. The three-dimensional virtual scenario is a virtual scenario provided when an application program runs on a terminal, may be a simulation scenario of a real world, or may be a semi-simulation and semi-fictional scenario, or may be a purely fictional scenario. The scenario picture displayed on the graphical user interface is a scenario picture presented when the virtual object observes the three-dimensional virtual scenario. A user controls the virtual object in the game scenario through the terminal. The virtual object may observe the three-dimensional virtual scenario through a camera model. Taking a FPS game as an example, from a first-person perspective, the camera model is located on the head or neck of the target virtual object, and only an arm portion of a virtual character can be displayed on the graphical user interface; and from a third-person perspective, the camera model is located behind the target virtual object, and only an upper body portion of the virtual character can be displayed on the graphical user interface. The graphical user interface is a scenario picture presented by observing the three-dimensional virtual scenario from a certain perspective through the camera model.

Specifically, referring to FIG. 1c, FIG. 1c is a first schematic diagram of a graphical user interface provided in an embodiment of the present disclosure. The graphical user interface is presented on a screen of the computer device 1000. The graphical user interface includes, e.g., a user-controlled target virtual object 10, the target virtual object 10 being configured with a virtual firearm, by which firing and shooting are performed, a shooting aiming mark 20 configured to assist the virtual firearm in aiming, a cursor widget 30 that notifies a user of current direction information of the target virtual object 10, a movement widget 40 that controls the virtual object 10 to move in a three-dimensional virtual environment, an aiming widget 50 that can be used by the target virtual object 10 for attacking, a map widget 60 that notifies the user of a location of the first virtual object 10 in the three-dimensional virtual environment, and a firing widget 70 that controls the target virtual object 10 to perform firearm shooting in the three-dimensional virtual environment. The cursor widget 30 is further provided with an indication widget 31 configured to indicate a direction of the first virtual object 10 in the cursor widget 30. It can be understood that the graphical user interface not only includes the above marks and widgets, but also may include other functional widgets or marks, which depend on specific game contents, and are not limited here.

Specifically, the graphical user interface further includes a second-type attack widget 80. The second-type attack widget 80 is used to control the target virtual object 10 to perform an attack in a second-type attack mode. The second-type attack mode is different from a first-type attack mode of performing firing and shooting using the virtual firearm, and may be, e.g., a melee attack or skill release, which is not limited here.

Step 102: replacing, in response to a touch operation for the second-type attack widget, the shooting aiming mark with a second-type aiming mark, and determining a to-be-attacked virtual object aimed at by the second-type aiming mark based on the touch operation, where the second-type aiming mark is used to assist in aiming of a second-type attack.

As shown in FIG. 1d, FIG. 1d is a second schematic diagram of a graphical user interface provided in an embodiment of the present disclosure. When performing the touch operation on the second-type attack widget 80, the user will replace the original shooting aiming mark 20 in the graphical user interface with the second-type aiming mark 90 for assisting in the second-type attack, thereby informing the user by the aiming mark replacement of changing the attack type from the original firing and shooting using the virtual firearm to the second-type attack mode.

Specifically, the second-type aiming mark 90 is used to determine the to-be-attacked virtual object based on the touch operation.

In some embodiments, the step of the determining the to-be-attacked virtual object aimed at by the second-type aiming mark based on the touch operation further includes:
(1) determining whether a further virtual object is present within a display range of the second-type aiming mark; and
(2) determining, in response to a further virtual object being present within the display range of the second-type aiming mark, the further virtual object as the to-be-attacked virtual object, and controlling the second-type aiming mark to be aimed at the to-be-attacked virtual object.

As shown in FIG. 1e, FIG. 1e is a third schematic diagram of a graphical user interface provided in an embodiment of the present disclosure. The second-type aiming mark 90 has a corresponding display range A in the graphical user interface. When a third candidate virtual object is present within the display range of the second-type aiming mark (a part of the head of the third candidate virtual object in FIG. 1e and the virtual firearm configured therewith fall within the display range A), the third candidate virtual object is determined as the to-be-attacked virtual object, and the second-type aiming mark 90 is controlled to be aimed at the to-be-attacked virtual object.

Specifically, the aiming is implemented by aligning the center point of the second-type aiming mark 90 with the to-be-attacked virtual object. The aiming mode may be changing the position of the second-type aiming mark 90 in the graphical user interface given that the viewing angle orientation remains unchanged; or changing the viewing angle orientation given that the position of the second-type aiming mark 90 in the graphical user interface remains unchanged, which is not limited here.

In some embodiments, the second-type attack widget 80 further includes an energy progress bar 81, the second-type attack mode includes a first sub-attack mode and a second sub-attack mode, and the energy progress bar 81 is used to notify whether an attack can be performed in the second sub-attack mode of the second-type attack mode.

As shown in FIG. 1f, FIG. 1f is a fourth schematic diagram of a graphical user interface provided in an embodiment of the present disclosure. Based on current energy 82 in the energy progress bar 81, two sub-attack modes are set for the second-type attack mode, namely the first sub-attack mode and the second sub-attack mode. For example, when the second-type attack mode is a melee attack, and when the current energy 82 fails to reach an upper limit, the target virtual object performs the melee attack using fists; and when the current energy 82 reaches the upper limit, the target virtual object performs a remote attack by releasing skills. In this case, the melee attack using fists is the first sub-attack mode, and the remote attack by releasing skills is the second sub-attack mode. Therefore, the energy progress bar 81 is used to notify the user whether an attack can be performed in the second sub-attack mode of the second-type attack mode.

Specifically, when the attack is performed in the second sub-attack mode, the energy bar will change from the original upper limit state to a lower limit state of no energy, and the energy will increase over time.

In some embodiments, the touch operation is a clicking operation; and
the step of the determining the to-be-attacked virtual object aimed at by the second-type aiming mark based on the touch operation includes:
(1) determining, when the current energy of the energy progress bar fails to reach the upper limit, a plurality of first candidate virtual objects within a first distance from the target virtual object; and
(2) determining the to-be-attacked virtual object from the plurality of first candidate virtual objects, and controlling the second-type aiming mark to be aimed at the to-be-attacked virtual object.

When the touch operation of the user for the second-type attack widget is a clicking operation, whether the current energy in the energy progress bar reaches the upper limit is determined. If the current energy fails to reach the upper limit, the first sub-attack mode of performing a melee attack using fists is determined. Therefore, the plurality of first candidate virtual objects within the first distance from the target virtual object are determined. The first distance is an attack distance of the melee attack using fists, such as 1 meter. The plurality of first candidate virtual objects are determined, for example, three virtual objects are present within 1 meter from the target virtual object, the three virtual objects are all determined as the first candidate virtual objects, and the to-be-attacked virtual object is selected from the first candidate virtual objects.

Specifically, the selection may be performed based on a preset selection rule. The preset selection rule may be comparing a distance between each of the first candidate virtual objects and the target virtual object, and determining a first candidate virtual object with a smallest distance as the to-be-attacked virtual object. For example, a distance between the first candidate virtual object A and the target virtual object is 0.8 meters, a distance between the first candidate virtual object B and the target virtual object is 0.5 meters, and then the first candidate virtual object B is determined as the to-be-attacked virtual object. The preset selection rule may also be determining a current viewing angle orientation, determining an angle value between a line segment formed by each first candidate virtual object and the target virtual object and the current viewing angle orientation, and determining a first candidate virtual object with a smallest angle value as the target virtual object. This selection rule can avoid the problem of failure to determine a direction by the user in a short time due to an excessive rotation angle of the viewing angle.

When the to-be-attacked virtual object is determined, the second-type aiming mark is aimed at the to-be-attacked virtual object, to notify the user that the virtual object attacked in the second-type attack mode is the to-be-attacked virtual object.

In some embodiments, the method further includes:
(1) determining, when the current energy of the energy progress bar reaches the upper limit, a plurality of second candidate virtual objects between a first distance and a second distance from the target virtual object, the second distance being larger than the first distance; and
(2) determining a to-be-attacked virtual object from the plurality of second candidate virtual objects, and controlling the second-type aiming mark to be aimed at the to-be-attacked virtual object.

When the current energy reaches the upper limit, the second sub-attack mode of performing a remote attack by releasing skills is determined. Therefore, the plurality of second candidate virtual objects between the first distance and the second distance from the target virtual object are determined. The second distance is an attack distance of the second sub-attack mode. Due to the remote attack, the target of the attack is set between the first distance and the second distance, the to-be-attacked virtual object is determined from the plurality of second candidate virtual objects based on the preset selection rule, and the second-type aiming mark is controlled to be aimed at the to-be-attacked virtual object.

In some embodiments, the second sub-attack mode is a remote attack, and the step of the controlling the target virtual object to attack the to-be-attacked virtual object in the second sub-attack mode includes:
(1) determining whether the second-type aiming mark is aimed at the to-be-attacked virtual object; and
(2) controlling, in response to the second-type aiming mark failing to be aimed at the to-be-attacked virtual object, the remote attack launched in the second sub-attack mode to attack the to-be-attacked virtual object.

The second sub-attack mode is a remote attack such as skill release or virtual prop throwing. When the target virtual object is controlled to attack the to-be-attacked virtual object in the second sub-attack mode, whether the second-type aiming mark is aimed at the to-be-attacked virtual object during the attack may be determined. If the second-type aiming mark fails to be aimed at the to-be-attacked virtual object, the target virtual object is controlled to remotely attack the to-be-attacked virtual object to form an attack mode of tracking attack.

In some embodiments, the method further includes:
controlling, in response to the second-type aiming mark failing to be aimed at the to-be-attacked virtual object, the second-type aiming mark to gradually approach the to-be-attacked virtual object during the attack in the second sub-attack mode, to be aimed at the to-be-attacked virtual object.

If the second-type aiming mark fails to be aimed at the to-be-attacked virtual object, the attack launched in the second sub-attack mode will not hit the to-be-attacked virtual object, and aiming correction may be performed to assist the user to aim at the to-be-attacked virtual object.

Specifically, the aiming correction mode is classified into two modes for the attack process of the second sub-attack mode. If the second sub-attack mode is a continuous attack, the second-type aiming mark may be controlled in the attack process of the continuous attack to gradually approach the to-be-attacked virtual object, to be aimed at the to-be-attacked virtual object; if the second sub-attack mode is a single attack, the second-type aiming mark may be controlled after the attack process of the single attack to gradually approach the to-be-attacked virtual object, to be aimed at the to-be-attacked virtual object. Although the single attack fails to hit the to-be-attacked virtual object, the second-type aiming mark has been approaching and aiming at the to-be-attacked virtual object, thereby allowing the user to increase the hit rate during a next single attack in the second sub-attack mode.

In some embodiments, the step of the controlling the target virtual object to attack the to-be-attacked virtual object in the second sub-attack mode includes:
controlling the second-type aiming mark to be aimed at the to-be-attacked virtual object, and controlling the target virtual object to attack the to-be-attacked virtual object in the second sub-attack mode.

In addition to the mode of assisting in aiming, the second-type aiming mark may also be controlled based on the control operation of the user to be aimed at the to-be-attacked virtual object, and the target virtual object may be controlled to attack the to-be-attacked virtual object in the second sub-attack mode.

In some embodiments, the touch operation is a sliding operation; and
the step of the determining the to-be-attacked virtual object aimed at by the second-type aiming mark based on the touch operation includes:
(1) adjusting an aiming orientation of the second-type aiming mark based on the sliding operation;
(2) determining, when a third candidate virtual object is present in the current aiming orientation and the sliding operation is ended, whether a progress of the energy progress bar reaches an upper limit; and
(3) determining, in response to current energy of the energy progress bar failing to reach the upper limit and a distance between the third candidate virtual object and the target virtual object being located within a first distance, the third candidate virtual object as the to-be-attacked virtual object.

As shown in FIG. 1g, FIG. 1g is a fifth schematic diagram of a graphical user interface provided in an embodiment of the present disclosure. The touch operation of the user for the second-type attack widget 80 is a sliding operation. The sliding operation can drive the second-type attack widget 80 to slide in the graphical user interface, thereby adjusting the aiming orientation of the second-type aiming mark. When the third candidate virtual object is detected to be present in the current aiming orientation, and the sliding operation is ended, it is confirmed that the user has selected an attack orientation, and the third candidate virtual object is present in the attack orientation. Whether the progress of the energy progress bar reaches the upper limit is determined. If the progress fails to reach the upper limit, an attack is performed in the first sub-attack mode. Therefore, it is necessary to determine whether the distance between the user-selected third candidate virtual object and the target virtual object is located within the attack distance (first distance) of the first sub-attack mode. If the distance between the user-selected third candidate virtual object and the target virtual object is located within the attack distance of the first sub-attack mode, the third candidate virtual object is determined as the to-be-attacked virtual object.

In some embodiments, the method further includes:
determining, in response to the current energy of the energy progress bar reaching the upper limit and the distance between the third candidate virtual object and the target virtual object being located between the first distance and a second distance, the third candidate virtual object as the to-be-attacked virtual object.

If the current energy reaches the upper limit, an attack is performed in the second sub-attack mode, and it is necessary to determine whether the distance between the user-selected third candidate virtual object and the target virtual object is located between the first distance and the second distance. If the distance between the user-selected third candidate virtual object and the target virtual object is located between the first distance and the second distance, the third candidate virtual object is determined as the to-be-attacked virtual object.

In some embodiments, before the step of the adjusting the aiming orientation of the second-type aiming mark based on the sliding operation, the method further includes:
displaying, in response to a pressing operation for the second-type attack widget, a sliding response region in the graphical user interface; and
the step of the adjusting the aiming orientation of the second-type aiming mark based on the sliding operation includes:
(1) determining, in response to the sliding operation in the sliding response region, a sliding direction, a sliding duration, and a sliding distance of the sliding operation;
(2) calculating a ratio of the sliding distance to the sliding duration to obtain a target sliding velocity;
(3) determining a target adjustment angle corresponding to the target sliding velocity based on a mapping relationship between the sliding velocity and the adjustment angle; and
(4) adjusting the aiming orientation of the second-type aiming mark based on the current aiming orientation of the second-type aiming mark, the sliding direction, and the target adjustment angle.

As shown in FIG. 1h, FIG. 1h is a sixth schematic diagram of a graphical user interface provided in an embodiment of the present disclosure. Before adjusting the aiming orientation of the second-type aiming mark through the sliding operation, the user will perform a pressing operation on the second-type attack widget, thereby displaying a sliding response region B in the graphical user interface. The sliding response region B may share a same center of circle as the second-type aiming mark before sliding, and has a larger radius than the second-type aiming mark, to inform the user that the second-type aiming mark can be dragged through the sliding operation to slide within the sliding response region B.

Specifically, the aiming orientation of the second-type aiming mark may be adjusted based on the sliding operation by: determining the sliding direction, the sliding duration, and the sliding distance of the sliding operation, for example, rightward sliding direction for the sliding duration of 1s and the sliding distance of 10 mm; calculating the ratio of the sliding distance to the sliding duration to obtain the target sliding velocity, for example, 10 mm/1 s=10 mm/s; determining the target adjustment angle corresponding to the target sliding velocity based on the mapping relationship between the sliding velocity and the adjustment angle, for example, the target adjustment angle corresponding to 10 mm/s is 90°; and adjusting the aiming orientation of the second-type aiming mark based on the current aiming orientation, the sliding direction, and the target adjustment angle of the second-type aiming mark, for example, the current aiming orientation of the second-type aiming mark is due north with rightward sliding direction and the target adjustment angle of 90°, then the second-type aiming mark is controlled to be adjusted rightward by 90° from the due north, and the final aiming orientation is due east.

In some embodiments, the graphical user interface further includes an attack cancel widget, and the method further includes:
prohibiting, when the sliding operation slides to the attack cancel widget, the target virtual object from performing an attack in the second-type attack mode.

As shown in FIG. li, FIG. li is a seventh schematic diagram of a graphical user interface provided in an embodiment of the present disclosure. An attack cancel widget 100 is displayed in the graphical user interface. When the sliding operation is detected to slide to the attack cancel widget, it means that the user would like to cancel the attack in the second-type attack mode, and the target virtual object is prohibited from performing the attack in the second-type attack mode.

Specifically, the attack cancel widget 100 may be displayed in the graphical user interface when the user performs a sliding operation for the second-type attack widget, or may be directly displayed in the graphical user interface when the game starts, which is not limited here.

Step 103: controlling the target virtual object to attack the to-be-attacked virtual object in a second-type attack mode.

After the to-be-attacked virtual object is determined in the step 102, the target virtual object may be controlled to attack the to-be-attacked virtual object in the second-type attack mode.

Specifically, depending on whether the current energy reaches the upper limit, the attack may be performed in the first sub-attack mode or the second sub-attack mode of the second-type attack mode.

In some embodiments, the step of the controlling the target virtual object to attack the to-be-attacked virtual object in the second-type attack mode includes:
controlling the target virtual object to attack the to-be-attacked virtual object in the first sub-attack mode.

In response to the touch operation being a clicking operation, after the to-be-attacked virtual object is determined when the current energy fails to reach the upper limit, the target virtual object is controlled to attack the to-be-attacked virtual object in the first sub-attack mode.

In some embodiments, the step of the controlling the target virtual object to attack the to-be-attacked virtual object in the second-type attack mode includes:
controlling the target virtual object to attack the to-be-attacked virtual object in the second sub-attack mode.

In response to the touch operation being a clicking operation, after the to-be-attacked virtual object is determined when the current energy reaches the upper limit, the target virtual object is controlled to attack the to-be-attacked virtual object in the second sub-attack mode.

In some embodiments, the step of the controlling the target virtual object to attack the to-be-attacked virtual object in the second-type attack mode includes:
controlling the target virtual object to attack the to-be-attacked virtual object in the first sub-attack mode.

In response to the touch operation being a sliding operation, after the to-be-attacked virtual object is determined when the current energy fails to reach the upper limit, the target virtual object is controlled to attack the to-be-attacked virtual object in the first sub-attack mode.

In some embodiments, the step of the controlling the target virtual object to attack the to-be-attacked virtual object in the second-type attack mode includes:
controlling the target virtual object to attack the to-be-attacked virtual object in the second sub-attack mode.

In response to the touch operation being a sliding operation, after the to-be-attacked virtual object is determined when the current energy reaches the upper limit, the target virtual object is controlled to attack the to-be-attacked virtual object in the second sub-attack mode.

In some embodiments, when a further virtual object is present in the aiming orientation of the second-type aiming mark, a display color of the second-type aiming mark is updated.

When a further virtual object is present in the aiming orientation of the second-type aiming mark (e.g., when the second-type aiming mark is aimed at the further virtual object), the display color of the second-type aiming mark is updated.

For example, the display color of the second-type aiming mark is white when the second-type aiming mark fails to be aimed at the further virtual object. When the second-type aiming mark is aimed at the further virtual object, the display color of the second-type aiming mark is red, thus notifying the user that the second-type aiming mark is aimed at the further virtual object.

As can be seen from the above description, in embodiments of the present disclosure, a graphical user interface is displayed, where the graphical user interface includes at least a part of a virtual scenario, a target virtual object located in the virtual scenario, a shooting aiming mark, and a second-type attack widget, the target virtual object is configured with a virtual firearm, and the shooting aiming mark is used to assist in aiming of the virtual firearm; in response to a touch operation for the second-type attack widget, the shooting aiming mark is replaced with a second-type aiming mark, a to-be-attacked virtual object aimed at by the second-type aiming mark is determined based on the touch operation, the second-type aiming mark is used to assist in aiming of the second-type attack; and the target virtual object is controlled to attack the to-be-attacked virtual object in a second-type attack mode. In this way, by the touch operation of a user on the second-type attack widget, the original attack mode using a virtual firearm is transformed into the second-type attack mode, thereby combining a plurality of game types, improving the game play, and increasing the fun.

In order to facilitate better implementation of the method for controlling a virtual object provided in the embodiments of the present disclosure, an embodiment of the present disclosure further provides an apparatus based on the above method for controlling a virtual object. Meanings of the terms are same as those in the above method for controlling a virtual object. The description in the method embodiments may be referred to for specific implementation details.

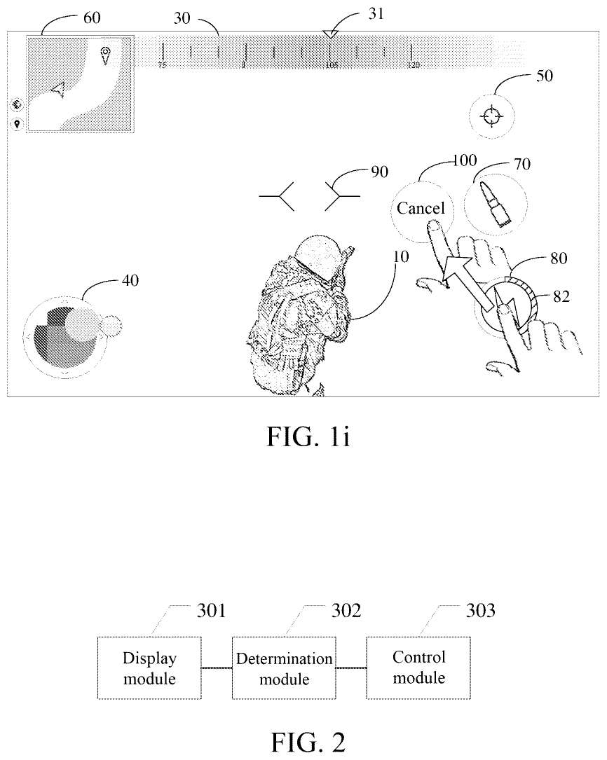

Referring to FIG. 2, FIG. 2 is a schematic structural diagram of an apparatus for controlling a virtual object provided in an embodiment of the present disclosure, where the apparatus for controlling a virtual object may include, e.g., a display module 301, a determination module 302, and a control module 303.

The display module 301 is configured to display a graphical user interface, where the graphical user interface includes at least a part of a virtual scenario, a target virtual object located in the virtual scenario, a shooting aiming mark, and a second-type attack widget, the target virtual object is configured with a virtual firearm, and the shooting aiming mark is used to assist in aiming of the virtual firearm;
the determination module 302 is configured to replace, in response to a touch operation for the second-type attack widget, the shooting aiming mark with a second-type aiming mark, and determine a to-be-attacked virtual object aimed at by the second-type aiming mark based on the touch operation, where the second-type aiming mark is used to assist in aiming of a second-type attack; and
the control module 303 is configured to control the target virtual object to attack the to-be-attacked virtual object in a second-type attack mode.

In some embodiments, the second-type attack widget further includes an energy progress bar, the second-type attack mode includes a first sub-attack mode and a second sub-attack mode, and the energy progress bar is used to notify whether an attack can be performed in the second sub-attack mode of the second-type attack mode.

In some embodiments, the touch operation is a clicking operation;
the determination module 302 includes:
a first determination submodule configured to determine, when current energy of the energy progress bar fails to reach an upper limit, a plurality of first candidate virtual objects within a first distance from the target virtual object; and
a second determination submodule configured to determine the to-be-attacked virtual object from the plurality of first candidate virtual objects, and control the second-type aiming mark to be aimed at the to-be-attacked virtual object; and
the control module 303 includes:
a first control submodule configured to control the target virtual object to attack the to-be-attacked virtual object in the first sub-attack mode.

In some embodiments, the determination module 302 further includes:
a third determination submodule configured to determine, when the current energy of the energy progress bar reaches the upper limit, a plurality of second candidate virtual objects between a first distance and a second distance from the target virtual object, the second distance being larger than the first distance; and
a fourth determination submodule configured to determine the to-be-attacked virtual object from the plurality of second candidate virtual objects, and control the second-type aiming mark to be aimed at the to-be-attacked virtual object; and
the control module 303 includes:
a second control submodule configured to control the target virtual object to attack the to-be-attacked virtual object in the second sub-attack mode.

In some embodiments, the second sub-attack mode is a remote attack, and the second control submodule includes:
a first determination unit configured to determine whether the second-type aiming mark is aimed at the to-be-attacked virtual object; and
a first control unit configured to control, in response to the second-type aiming mark failing to be aimed at the to-be-attacked virtual object, the remote attack launched in the second sub-attack mode to attack the to-be-attacked virtual object.

In some embodiments, the second control submodule further includes:
a second control unit configured to control, in response to the second-type aiming mark failing to be aimed at the to-be-attacked virtual object, the second-type aiming mark to gradually approach the to-be-attacked virtual object during the attack in the second sub-attack mode, to be aimed at the to-be-attacked virtual object.

In some embodiments, the second control submodule includes:
a third control unit configured to control the second-type aiming mark to be aimed at the to-be-attacked virtual object, and control the target virtual object to attack the to-be-attacked virtual object in the second sub-attack mode.

In some embodiments, the determination module 302 includes:
a fifth determination submodule configured to determine whether a further virtual object is present within a display range of the second-type aiming mark; and
a sixth determination submodule configured to determine, in response to a further virtual object being present within the display range of the second-type aiming mark, the further virtual object as the to-be-attacked virtual object, and control the second-type aiming mark to be aimed at the to-be-attacked virtual object.

In some embodiments, the touch operation is a sliding operation;
the determination module 302 includes:
an adjustment submodule configured to adjust an aiming orientation of the second-type aiming mark based on the sliding operation;
a seventh determination submodule configured to determine, when the third candidate virtual object is present in a current aiming orientation and the sliding operation is ended, whether a progress of the energy progress bar reaches an upper limit; and
an eighth determination submodule configured to determine, in response to current energy of the energy progress bar failing to reach the upper limit and a distance between the third candidate virtual object and the target virtual object being located within a first distance, the third candidate virtual object as the to-be-attacked virtual object; and
the control module 303 includes:
a third control submodule configured to control the target virtual object to attack the to-be-attacked virtual object in the first sub-attack mode.

In some embodiments, the determination module 302 further includes:
a seventh determination submodule configured to determine, in response to the current energy of the energy progress bar reaching the upper limit and the distance between the third candidate virtual object and the target virtual object being located between the first distance and a second distance, the third candidate virtual object as the to-be-attacked virtual object; and
the control module 303 includes:
a fourth control submodule configured to control the target virtual object to attack the to-be-attacked virtual object in the second sub-attack mode.

In some embodiments, the determination module 302 further includes:
a display submodule configured to display, in response to a pressing operation for the second-type attack widget, a sliding response region in the graphical user interface; and
the adjustment submodule includes:
a second determination unit configured to determine, in response to the sliding operation in the sliding response region, a sliding direction, a sliding duration, and a sliding distance of the sliding operation;
a calculation unit configured to calculate a ratio of the sliding distance to the sliding duration to obtain a target sliding velocity;
a third determination unit configured to determine a target adjustment angle corresponding to the target sliding velocity based on a mapping relationship between the sliding velocity and the adjustment angle; and
an adjustment unit configured to adjust the aiming orientation of the second-type aiming mark based on the current aiming orientation of the second-type aiming mark, the sliding direction, and the target adjustment angle.

In some embodiments, the graphical user interface further includes an attack cancel widget, and the apparatus further includes:
a prohibition module configured to prohibit, when the sliding operation slides to the attack cancel widget, the target virtual object from performing an attack in the second-type attack mode.

In some embodiments, when a further virtual object is present in the aiming orientation of the second-type aiming mark, a display color of the second-type aiming mark is updated.

As can be seen from the above description, in embodiments of the present disclosure, the display module 301 displays a graphical user interface, where the graphical user interface includes at least a part of a virtual scenario, a target virtual object located in the virtual scenario, a shooting aiming mark, and a second-type attack widget, the target virtual object is configured with a virtual firearm, and the shooting aiming mark is used to assist in aiming of the virtual firearm; the determination module 302 replaces, in response to a touch operation for the second-type attack widget, the shooting aiming mark with a second-type aiming mark, and determines a to-be-attacked virtual object aimed at by the second-type aiming mark based on the touch operation, the second-type aiming mark is used to assist in aiming of the second-type attack; and the control module 303 controls the target virtual object to attack the to-be-attacked virtual object in a second-type attack mode. In this way, by the touch operation of a user on the second-type attack widget, the original attack mode using a virtual firearm is transformed into the second-type attack mode, thereby combining a plurality of game types, improving the game play, and increasing the fun.

The above embodiments may be referred to for specific implementations of the above operations, which will not be repeated here.

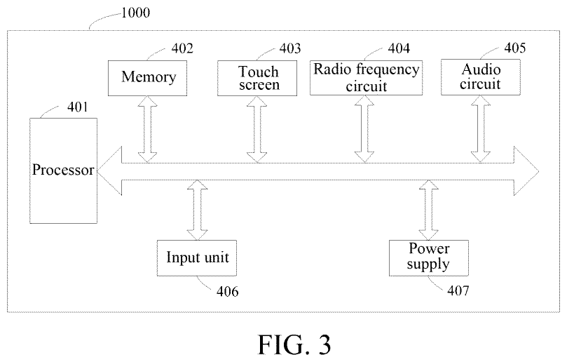

Accordingly, an embodiment of the present disclosure further provides a computer device. The computer device may be a terminal or a server. The terminal may be a terminal device, such as a smart phone, a tablet computer, a notebook computer, a touch screen, a game machine, a personal computer (PC), or a personal digital assistant (PDA). As shown in FIG. 3, FIG. 3 is a schematic structural diagram of a computer device provided in an embodiment of the present disclosure. The computer device 1000 includes a processor 401 having one or more than one processing core, a memory 402 having one or more than one computer-readable storage medium, and a computer program stored on the memory 402 and runnable on the processor. The processor 401 is electrically connected to the memory 402. Those skilled in the art can understand that the structure of the computer device shown in the figure does not constitute any limitation to the computer device, and may include more or fewer components than those shown in the figure, or may combine some components, or may have different component arrangements.

The processor 401 is a control center of the computer device 1000, connects various parts of the entire computer device 1000 using various interfaces and wires, implements various functions of the computer device 1000 by running or loading software programs and/or modules stored in the memory 402, and implements data processing by invoking data stored in the memory 402, thereby performing overall monitoring on the computer device 1000.

In an embodiment of the present disclosure, the processor 401 in the computer device 1000 will load instructions corresponding to processes of one or more than one application program into the memory 402 following the steps below, and the processor 401 runs the application program stored in the memory 402, thereby implementing various functions:
displaying a graphical user interface, where the graphical user interface includes at least a part of a virtual scenario, a target virtual object located in the virtual scenario, a shooting aiming mark, and a second-type attack widget, the target virtual object is configured with a virtual firearm, and the shooting aiming mark is used to assist in aiming of the virtual firearm; replacing, in response to a touch operation for the second-type attack widget, the shooting aiming mark with a second-type aiming mark, determining a to-be-attacked virtual object aimed at by the second-type aiming mark based on the touch operation, the second-type aiming mark being used to assist in aiming of the second-type attack; and controlling the target virtual object to attack the to-be-attacked virtual object in a second-type attack mode.

The above embodiments may be referred to for specific implementations of the above operations, which will not be repeated here.

In some embodiments, as shown in FIG. 3, the computer device 1000 further includes: a touch screen 403, a radio frequency circuit 404, an audio circuit 405, an input unit 406, and a power supply 407. The processor 401 is electrically connected to the touch screen 403, the radio frequency circuit 404, the audio circuit 405, the input unit 406, and the power supply 407 respectively. Those skilled in the art can understand that the structure of the computer device shown in FIG. 3 does not constitute any limitation to the computer device, and may include more or fewer components than those shown in the figure, or may combine some components, or may have different component arrangements.

The touch screen 403 may be configured to display a graphical user interface and receive an operating instruction generated by a user acting on the graphical user interface. The touch screen 403 may include a display panel and a touch panel. The display panel may be configured to display information inputted by the user or information provided to the user, and various graphical user interfaces of the computer device. These graphical user interfaces may be composed of graphics, texts, icons, videos, and any combination thereof. In some embodiments, the display panel may be configured in the form of, e.g., a liquid crystal display (LCD) or an organic light-emitting diode (OLED). The touch panel may be configured to collect a touch operation of the user thereon or in the vicinity thereof (such as an operation of the user on or in the vicinity of the touch panel using a finger, a touch pen, or any appropriate object or accessory), and generate a corresponding operating instruction, which executes a corresponding program. In some embodiments, the touch panel may include two parts: a touch detection apparatus and a touch controller. The touch detection apparatus detects a touch orientation of the user, detects a signal brought by the touch operation, and transmits the signal to the touch controller. The touch controller receives touch information from the touch detection apparatus, converts it into contact point coordinates, then transmits the contact point coordinates to the processor 401, can receive a command transmitted from the processor 401, and can execute the command. The touch panel can cover the display panel. After detecting the touch operation on or in the vicinity of the touch panel, the touch panel transmits the touch operation to the processor 401 to determine a type of a touch event, and then the processor 401 provides a corresponding visual output on the display panel based on the type of the touch event. In an embodiment of the present disclosure, the touch panel and the display panel may be integrated into the touch screen 403 to implement input and output functions. However, in some embodiments, the touch panel and the touch panel may be used as two standalone components to implement input and output functions. In this configuration, the touch screen 403 may also be used as a part of the input unit 406 to implement the input function.

In an embodiment of the present disclosure, the processor 401 executes a game application program to generate a graphical user interface on the touch display 403. A virtual scenario on the graphical user interface comprises at least one skill control region, and the skill control region comprises at least one skill widget. The touch screen 403 is configured to present a graphical user interface and receive an operating instruction generated by a user acting on the graphical user interface.

The radio frequency circuit 404 may be configured to transmit/receive a radio frequency signal, so as to establish wireless communication with a network device or other computer devices through wireless communication, and transmit/receive signals to/from the network device or other computer devices.

The audio circuit 405 may be configured to provide an audio interface between the user and the computer device through a speaker or a microphone. The audio circuit 405 can transmit an electrical signal converted from received audio data to the speaker, which converts the electrical signal into an acoustical signal and outputs the acoustical signal. On the other hand, the microphone converts the collected acoustical signal into an electrical signal, which is received by the audio circuit 405, and then converted into audio data. Then, the audio data is outputted to the processor 401 for processing, and then transmitted to, for example, another computer device through the radio frequency circuit 404, or the audio data is outputted to the memory 402 for further processing. The audio circuitry 405 may further include an earphone jack, to provide communication between a peripheral earphone and the computer device.

The input unit 406 may be configured to receive an inputted number, character information, or user feature information (such as a fingerprint, an iris, or facial information), and generate keyboard, mouse, joystick, optical or trackball signal input related to user settings and function control.

The power supply 407 is configured to power various components of the computer device 1000. In some embodiments, the power supply 407 may be logically connected to the processor 401 through a power management system, thereby managing functions such as charging, discharging, and power consumption management through the power management system. The power supply 407 may further include one or more than one DC or AC power supply, a recharging system, a power failure detection circuit, a power converter or inverter, a power status indicator, and any other components.

Although not shown in FIG. 3, the computer device 1000 may further include, e.g., a camera, a sensor, a wireless fidelity module, and a Bluetooth module, which will not be repeated here.

In the above embodiments, particular emphasis is laid on description of each embodiment. Relevant descriptions of other embodiments may be referred to for parts that are not described in detail in an embodiment.

As can be seen from the above, the computer device provided in the present embodiment displays a graphical user interface, where the graphical user interface includes at least a part of a virtual scenario, a target virtual object located in the virtual scenario, a shooting aiming mark, and a second-type attack widget, the target virtual object is configured with a virtual firearm, and the shooting aiming mark is used to assist in aiming of the virtual firearm; replaces, in response to a touch operation for the second-type attack widget, the shooting aiming mark with a second-type aiming mark, determines a to-be-attacked virtual object aimed at by the second-type aiming mark based on the touch operation, the second-type aiming mark being used to assist in aiming of the second-type attack; and controls the target virtual object to attack the to-be-attacked virtual object in a second-type attack mode. In this way, by the touch operation of a user on the second-type attack widget, the original attack mode using a virtual firearm is transformed into the second-type attack mode, thereby combining a plurality of game types, improving the game play, and increasing the fun.

Those of ordinary skills in the art can understand that all or a part of the steps in the methods of the above embodiments can be completed through instructions, or be completed by controlling related hardware through instructions, where the instructions may be stored in a computer-readable storage medium, and loaded and executed by a processor.

To this end, an embodiment of the present disclosure provides a computer-readable storage medium in which a plurality of computer programs are stored. The computer programs can be loaded by a processor to implement steps in any one method for controlling a skill provided in embodiments of the present disclosure. For example, the computer programs can implement the following steps:
displaying a graphical user interface, where the graphical user interface includes at least a part of a virtual scenario, a target virtual object located in the virtual scenario, a shooting aiming mark, and a second-type attack widget, the target virtual object is configured with a virtual firearm, and the shooting aiming mark is used to assist in aiming of the virtual firearm; replacing, in response to a touch operation for the second-type attack widget, the shooting aiming mark with a second-type aiming mark, determining a to-be-attacked virtual object aimed at by the second-type aiming mark based on the touch operation, the second-type aiming mark being used to assist in aiming of the second-type attack; and controlling the target virtual object to attack the to-be-attacked virtual object in a second-type attack mode.

In some embodiments, the second-type attack widget further includes an energy progress bar, the second-type attack mode includes a first sub-attack mode and a second sub-attack mode, and the energy progress bar is used to notify whether an attack can be performed in the second sub-attack mode of the second-type attack mode.

In some embodiments, the touch operation is a clicking operation;
the step of the determining the to-be-attacked virtual object aimed at by the second-type aiming mark based on the touch operation includes:
determining, when current energy of the energy progress bar fails to reach an upper limit, a plurality of first candidate virtual objects within a first distance from the target virtual object; and
determining the to-be-attacked virtual object from the plurality of first candidate virtual objects, and controlling the second-type aiming mark to be aimed at the to-be-attacked virtual object; and
the step of the controlling the target virtual object to attack the to-be-attacked virtual object in the second-type attack mode includes:
controlling the target virtual object to attack the to-be-attacked virtual object in the first sub-attack mode.

In some embodiments, the method further includes:
determining, when the current energy of the energy progress bar reaches the upper limit, a plurality of second candidate virtual objects between a first distance and a second distance from the target virtual object, the second distance being larger than the first distance; and
determining the to-be-attacked virtual object from the plurality of second candidate virtual objects; and
the step of the controlling the target virtual object to attack the to-be-attacked virtual object in the second-type attack mode includes:
controlling the target virtual object to attack the to-be-attacked virtual object in the second sub-attack mode.

In some embodiments, the second sub-attack mode is a remote attack, and the step of the controlling the target virtual object to attack the to-be-attacked virtual object in the second sub-attack mode includes:
determining whether the second-type aiming mark is aimed at the to-be-attacked virtual object; and
controlling, in response to the second-type aiming mark failing to be aimed at the to-be-attacked virtual object, the remote attack launched in the second sub-attack mode to attack the to-be-attacked virtual object.

The above embodiments may be referred to for specific implementations of the above operations, which will not be repeated here.

The storage medium may include, e.g., a read only memory (ROM), a random access memory (RAM), and a magnetic disk or an optical disk.

Since the computer programs stored in the storage medium can implement the steps in any one method for controlling a virtual object provided in the embodiments of the present disclosure, the beneficial effects that can be achieved by any one method for controlling a virtual object provided in the embodiments of the present disclosure can be achieved, details of which are shown in the above embodiments and will not be repeated here.

The method for controlling a virtual object, the apparatus for controlling a virtual object, the storage medium, and the computer device provided in the embodiments of the present disclosure are introduced in detail above. Specific examples are used herein to illustrate the principles and implementations of the present disclosure. The description of the above embodiments is only provided to help in understanding the method of the present disclosure and core concept thereof. Moreover, those skilled in the art will make alterations to the specific embodiments and application scope based on the concept of the present disclosure. To sum up, the content of the present specification should not be construed as limiting the present disclosure.

1. A method for controlling a virtual object, comprising:
displaying a graphical user interface, wherein the graphical user interface comprises a virtual scenario, a target virtual object located in the virtual scenario, a shooting aiming mark, and a second-type attack widget, the target virtual object is configured with a virtual firearm, and the shooting aiming mark is configured to assist in aiming of the virtual firearm;
in response to a touch operation for the second-type attack widget:
replacing the shooting aiming mark with a second-type aiming mark, and
determining a to-be-attacked virtual object aimed at by the second-type aiming mark based on the touch operation, wherein the second-type aiming mark is configured to assist in aiming of a second-type attack; and
controlling the target virtual object to attack the to-be-attacked virtual object in a second-type attack mode.

2. The method for controlling the virtual object according to claim 1, wherein the second-type attack widget further comprises an energy progress bar, the second-type attack mode comprises a first sub-attack mode and a second sub-attack mode, and the energy progress bar is configured to notify whether an attack can be performed in the second sub-attack mode of the second-type attack mode.

3. The method for controlling the virtual object according to claim 2, wherein the touch operation comprises a clicking operation,
determining the to-be-attacked virtual object aimed at by the second-type aiming mark based on the touch operation comprises:
determining, in response to detecting that the energy progress bar fails to reach an upper limit, a plurality of first candidate virtual objects within a first distance from the target virtual object;
determining the to-be-attacked virtual object from the plurality of first candidate virtual objects;
controlling the second-type aiming mark to be aimed at the to-be-attacked virtual object, and
controlling the target virtual object to attack the to-be-attacked virtual object in the second-type attack mode comprises:
controlling the target virtual object to attack the to-be-attacked virtual object in the first sub-attack mode.

4. The method for controlling the virtual object according to claim 3, wherein the method further comprises:
determining, in response to detecting that the energy progress bar reaches the upper limit, a plurality of second candidate virtual objects between the first distance and a second distance from the target virtual object, the second distance being larger than the first distance; and
determining the to-be-attacked virtual object from the plurality of second candidate virtual objects, and
controlling the target virtual object to attack the to-be-attacked virtual object in the second-type attack mode comprises:
controlling the target virtual object to attack the to-be-attacked virtual object in the second sub-attack mode.

5. The method for controlling the virtual object according to claim 4, wherein the second sub-attack mode comprises a remote attack, and controlling the target virtual object to attack the to-be-attacked virtual object in the second sub-attack mode comprises:
determining that the second-type aiming mark is not aimed at the to-be-attacked virtual object; and
controlling, in response to the determination, the remote attack launched in the second sub-attack mode to attack the to-be-attacked virtual object.

6. The method for controlling the virtual object according to claim 5, wherein the method further comprises:
controlling, in response to the second-type aiming mark failing to be aimed at the to-be-attacked virtual object, the second-type aiming mark to gradually approach the to-be-attacked virtual object during the remote attack in the second sub-attack mode, to be aimed at the to-be-attacked virtual object.

7. The method for controlling the virtual object according to claim 4, wherein controlling the target virtual object to attack the to-be-attacked virtual object in the second sub-attack mode comprises:
controlling the second-type aiming mark to be aimed at the to-be-attacked virtual object; and
controlling the target virtual object to attack the to-be-attacked virtual object in the second sub-attack mode.

8. The method for controlling the virtual object according to claim 1, wherein determining the to-be-attacked virtual object aimed at by the second-type aiming mark based on the touch operation further comprises:
determining that a further virtual object is present within a display range of the second-type aiming mark; and
in response to the determination:
identifying the further virtual object as the to-be-attacked virtual object, and
controlling the second-type aiming mark to be aimed at the to-be-attacked virtual object.

9. The method for controlling the virtual object according to claim 2, wherein the touch operation comprises a sliding operation,
determining the to-be-attacked virtual object aimed at by the second-type aiming mark based on the touch operation comprises:
adjusting an aiming orientation of the second-type aiming mark based on the sliding operation;
determining, in response to detecting that a third candidate virtual object is present in a current aiming orientation and the sliding operation is ended, whether the energy progress bar reaches an upper limit; and
determining, in response to the energy progress bar failing to reach the upper limit and a distance between the third candidate virtual object and the target virtual object being located within a first distance, the third candidate virtual object as the to-be-attacked virtual object, and
controlling the target virtual object to attack the to-be-attacked virtual object in the second-type attack mode comprises:
controlling the target virtual object to attack the to-be-attacked virtual object in the first sub-attack mode.

10. The method for controlling the virtual object according to claim 9, wherein the method further comprises:
determining, in response to the energy progress bar reaching the upper limit and the distance between the third candidate virtual object and the target virtual object being located between the first distance and a second distance, the third candidate virtual object as the to-be-attacked virtual object, and
controlling the target virtual object to attack the to-be-attacked virtual object in the second-type attack mode comprises:
controlling the target virtual object to attack the to-be-attacked virtual object in the second sub-attack mode.

11. The method for controlling the virtual object according to claim 9, wherein before adjusting the aiming orientation of the second-type aiming mark based on the sliding operation, the method further comprises:
displaying, in response to a pressing operation for the second-type attack widget, a sliding response region in the graphical user interface, and
adjusting the aiming orientation of the second-type aiming mark based on the sliding operation comprises:
determining, in response to the sliding operation in the sliding response region, a sliding direction, a sliding duration, and a sliding distance of the sliding operation;
calculating a ratio of the sliding distance to the sliding duration to obtain a target sliding velocity;
determining a target adjustment angle corresponding to the target sliding velocity based on a mapping relationship between a sliding velocity and an adjustment angle; and
adjusting the aiming orientation of the second-type aiming mark based on a current aiming orientation of the second-type aiming mark, the sliding direction, and the target adjustment angle.

12. The method for controlling the virtual object according to claim 9, wherein the graphical user interface further comprises an attack cancel widget, and the method further comprises:
prohibiting, in response to detecting that the sliding operation slides to the attack cancel widget, the target virtual object from performing an attack in the second-type attack mode.

13. The method for controlling the virtual object according to claim 1, wherein the method further comprises updating, in response to detecting that a further virtual object is present in an aiming orientation of the second-type aiming mark, a display color of the second-type aiming mark.

14. (canceled)

15. One or more non-transitory computer-readable storage media containing, in any combination, computer program code that, when executable by a computer system, perform an operation comprising:
displaying a graphical user interface, wherein the graphical user interface comprises virtual scenario, a target virtual object located in the virtual scenario, a shooting aiming mark, and a second-type attack widget, the target virtual object is configured with a virtual firearm, and the shooting aiming mark is configured to assist in aiming of the virtual firearm;
in response to a touch operation for the second-type attack widget:
replacing the shooting aiming mark with a second-type aiming mark, and
determining a to-be-attacked virtual object aimed at by the second-type aiming mark based on the touch operation, wherein the second-type aiming mark is configured to assist in aiming of a second-type attack; and
controlling the target virtual object to attack the to-be-attacked virtual object in a second-type attack mode.

16. The one or more non-transitory computer-readable storage media according to claim 15, wherein the second-type attack widget further comprises an energy progress bar, the second-type attack mode comprises a first sub-attack mode and a second sub-attack mode, and the energy progress bar is configured to notify whether an attack can be performed in the second sub-attack mode of the second-type attack mode.

17. The one or more non-transitory computer-readable storage media according to claim 16, wherein the touch operation comprises a clicking operation,
determining the to-be-attacked virtual object aimed at by the second-type aiming mark based on the touch operation comprises:
determining, in response to detecting that the energy progress bar fails to reach an upper limit, a plurality of first candidate virtual objects within a first distance from the target virtual object; and
determining the to-be-attacked virtual object from the plurality of first candidate virtual objects; and
controlling the second-type aiming mark to be aimed at the to-be-attacked virtual object, and
controlling the target virtual object to attack the to-be-attacked virtual object in the second-type attack mode comprises:
controlling the target virtual object to attack the to-be-attacked virtual object in the first sub-attack mode.

18. The one or more non-transitory computer-readable storage media according to claim 17, wherein the operation further comprises:
determining, in response to detecting that the energy progress bar reaches the upper limit, a plurality of second candidate virtual objects between the first distance and a second distance from the target virtual object, the second distance being larger than the first distance; and
determining the to-be-attacked virtual object from the plurality of second candidate virtual objects, and
controlling the target virtual object to attack the to-be-attacked virtual object in the second-type attack mode comprises:
controlling the target virtual object to attack the to-be-attacked virtual object in the second sub-attack mode.

19. The one or more non-transitory computer-readable storage media according to claim 18, wherein the second sub-attack mode comprises a remote attack, and controlling the target virtual object to attack the to-be-attacked virtual object in the second sub-attack mode comprises:
determining that the second-type aiming mark is not aimed at the to-be-attacked virtual object; and
controlling, in response to the determination, the remote attack launched in the second sub-attack mode to attack the to-be-attacked virtual object.

20. A system, comprising:
one or more memories collectively containing one or more programs; and
one or more processors, wherein the one or more processors are configured to, individually or collectively, perform an operation comprising:
displaying a graphical user interface, wherein the graphical user interface comprises a virtual scenario, a target virtual object located in the virtual scenario, a shooting aiming mark, and a second-type attack widget, the target virtual object is configured with a virtual firearm, and the shooting aiming mark is configured to assist in aiming of the virtual firearm;
in response to a touch operation for the second-type attack widget:
replacing the shooting aiming mark with a second-type aiming mark, and
determining a to-be-attacked virtual object aimed at by the second-type aiming mark based on the touch operation, wherein the second-type aiming mark is configured to assist in aiming of a second-type attack; and
controlling the target virtual object to attack the to-be-attacked virtual object in a second-type attack mode.

21. The one or more non-transitory computer-readable storage media according to claim 15, wherein determining the to-be-attacked virtual object aimed at by the second-type aiming mark based on the touch operation further comprises:
determining that a further virtual object is present within a display range of the second-type aiming mark; and
in response to the determination:
identifying the further virtual object as the to-be-attacked virtual object, and
controlling the second-type aiming mark to be aimed at the to-be-attacked virtual object.
